(19) United States
(12) Patent Application Publication
(10) Pub. No.: US 2014/0004884 A1
(43) Pub. Date: Jan. 2, 2014

(54) INTERACTION SYSTEM

(71) Applicant: QUANTA COMPUTER INC., Kuei Shan Hsiang (TW)

(72) Inventors: Chia-Yuan Chang, Kuei Shan Hsiang (TW); Ting-Han Huang, Kuei Shan Hsiang (TW); Chih-Yin Lin, Kuei Shan Hsiang (TW); Yu-Chen Huang, Kuei Shan Hsiang (TW); Chia-Yi Wu, Kuei Shan Hsiang (TW); Tung-Jen Tsai, Kuei Shan Hsiang (TW); Juin-Yi Huang, Kuei Shan Hsiang (TW); Shin-Hau Huang, Kuei Shan Hsiang (TW); Kang-Wen Lin, Kuei Shan Hsiang (TW); Po-Chih Tsai, Kuei Shan Hsiang (TW); Ching-Fan Chu, Kuei Shan Hsiang (TW)

(73) Assignee: Quanta Computer Inc., Kuei Shan Hsiang (TW)

(21) Appl. No.: 13/788,419

(22) Filed: Mar. 7, 2013

(30) Foreign Application Priority Data
Jun. 27, 2012 (TW) 101122937

(51) Int. Cl. H04W 4/02

(52) U.S. Cl. CPC H04W 4/025
USPC 455/456.3; 455/456.1

(57) ABSTRACT

An interaction system is provided. The interaction system has: a mobile device having: a location detection unit configured to retrieve a geographical location of the mobile device; and a server configured to retrieve the geographical location of the mobile device, wherein the server has a database configured to store at least one interaction object and location information associated with the interaction object, and the server further determines whether the location information of the interaction object corresponds to the geographical location of the mobile device, wherein when the location information of the interaction object corresponds to the geographical location of the mobile device, the server further transmits the interaction object to the mobile device, so that the mobile device executes the at least one interaction object.

### CROSS REFERENCE TO RELATED APPLICATIONS

This Application claims priority of Taiwan Patent Application No. 101122937, filed on Jun. 27, 2012, the entirety of which is incorporated by reference herein.

### BACKGROUND OF THE INVENTION

1. Field of the Invention

The present invention relates to an interaction system, and in particular, relates to a located-based interaction system and method.

2. Description of the Related Art

With advances in technologies, mobile devices have become more and more popular. A mobile device on the market, such as a smart phone or a tablet PC, may have a global positioning system (GPS) or an assisted global positioning system (A-GPS) to retrieve the geographical location of the mobile device. However, a user may interact with other users by using the mobile device through a network or a community network, wherein the geographical information of the mobile device cannot be used sufficiently. In addition, the geographical information of the mobile device cannot be used on interaction objects (e.g. audio files, video files, or text messages) transmitted between different users. Thus, user interaction experience is hindered.

### BRIEF SUMMARY OF THE INVENTION

A detailed description is given in the following embodiments with reference to the accompanying drawings.

In an exemplary embodiment, an interaction system is provided. A user may have a better interaction experience when interacting with an interaction object by using the geographical location of a mobile device. The interaction system comprises: a mobile device comprising a location detection unit configured to retrieve a geographical location of the mobile device; and a server configured to retrieve the geographical location of the mobile device, wherein the server comprises a database configured to store at least one interaction object and location information associated with the interaction object, and the server further determines whether the location information of the interaction object corresponds to the geographical location of the mobile device, wherein when the location information of the interaction object corresponds to the geographical location of the mobile device, the server further transmits the interaction object to the mobile device, so that the mobile device executes the at least one interaction object.

### BRIEF DESCRIPTION OF THE DRAWINGS

The present invention can be more fully understood by reading the subsequent detailed description and examples with references made to the accompanying drawings, wherein:

FIG. 1 is a schematic diagram of an interaction system 10 according to an embodiment of the invention;

FIG. 2 is a flow chart illustrating a method for building an interaction object according to an embodiment of the invention;

FIG. 3 is a flow chart illustrating an interaction method according to an embodiment of the invention;

FIGS. 4A-4E are diagrams illustrating a complete procedure of interacting with an interaction object according to an embodiment of the invention;

FIG. 5 is a diagram illustrating an interaction action according to another embodiment of the invention;

FIG. 6 is a diagram illustrating an interaction action according to yet another embodiment of the invention; and

FIG. 7 is a diagram illustrating an interaction action according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

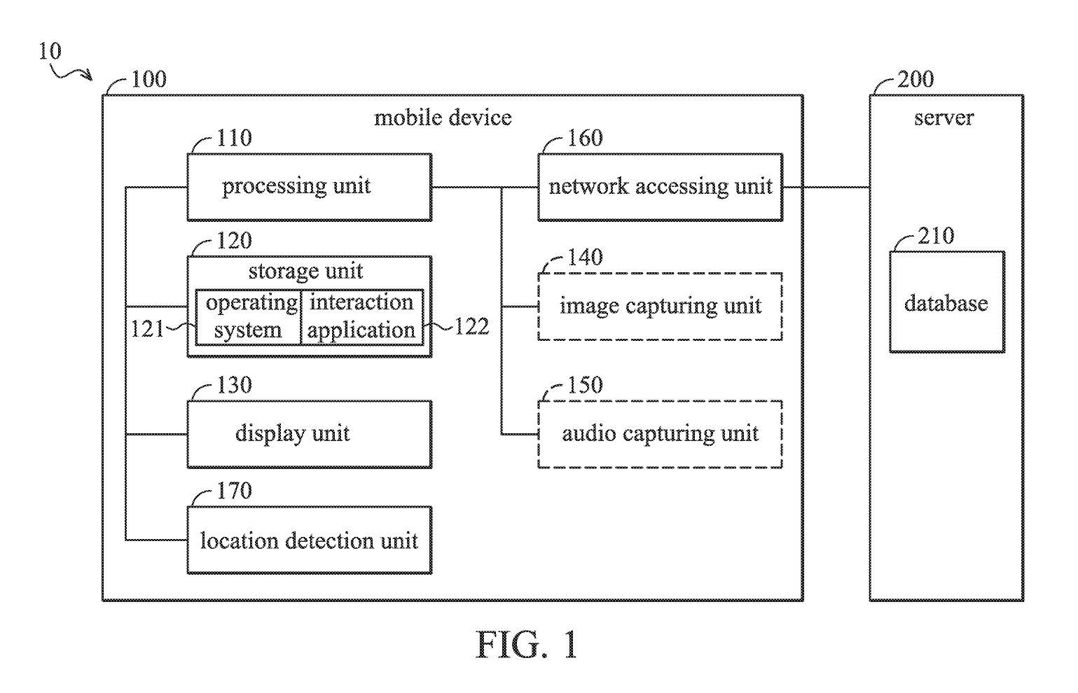

FIG. 1 is a schematic diagram of an interaction system 10 according to an embodiment of the invention. The interaction system 10 may comprise a mobile device 100 and a server 200. The mobile device 100 may comprise a processing unit 110, a storage unit 120, a display unit 130, a network accessing unit 160, and a location detection unit 170. In an embodiment, the interaction system 100 may be a portable electronic device, such as a smart phone, a tablet PC, or a laptop, but the invention is not limited thereto. The storage unit 120 is configured to store an operating system 121 (e.g. Windows, Android, or iOS, etc.) and an interaction application 122. The processing unit 110 may execute the operating system 121 as a platform, and execute the interaction application 122 to perform interaction (details will be described later). The mobile device 100 is coupled to the server 200 through the network accessing unit 160, thereby exchanging interaction information. The network accessing unit 160 may be a wired/wireless network interface supporting various communications standards, such as TCP/IP, Wifi (e.g. 802.11x), mobile communication standards, or communication networks, but the invention is not limited thereto. In another embodiment, the mobile device 100 may optionally comprise an image capturing unit 140 and/or an audio capturing unit 150. The image capturing unit 140 and the audio capturing unit 150 are configured to capture images and sounds, respectively. In addition, the processing unit 110 may selectively determine at least one interaction object, such as an image, a video, or an audio file, from the captured image or sounds according to a user's operation. Alternatively, the processing unit 110 may also retrieve an interaction object (e.g. a foreground object) from the captured image by performing an image recognition process to the captured image, and upload the retrieved interaction object to the server 200 through the network accessing unit 160. Reference can be made to prior techniques concerning the aforementioned image recognition process, thus, the details thereof will not be described here.

The location detection unit 170 is configured to detect a geographical location of the mobile device 100. For example, the location detection unit 170 may be a global positioning system (GPS), an assisted global positioning system (A-GPS), a radio frequency (RF) triangulation device, an electronic compass, or an inertial measurement unit (IMU), but the invention is not limited thereto. In an embodiment, when the location detection unit 170 cannot obtain an exact geographical location of the mobile device 100 (e.g. a GPS detector cannot detect positioning systems indoors), the mobile device 100 may capture an image by using the image capturing unit 140, and transmit the captured image to the server 200. Then, the server 200 may compare the captured image from the mobile device 100 with images having geographical information stored in a database 210, thereby determining the geographical location of the mobile device 100.

In an embodiment, the server 200 may comprise a database 210 configured to store at least one interaction object and corresponding geographical information. The server 200 may be a computer system. For a person having ordinary skill in the art, it is appreciated that a computer system is capable of performing operations, such analyzing and storing data. Details of components in the computer system will not be described here. The interaction objects to be analyzed in the server 200 may be obtained from the mobile device 100 by using the image capturing unit 140 or the audio capturing unit 150. Alternatively, the interaction objects may be preset in the server 200 (e.g. by the manufacturer or agent).

In an embodiment, the database 210 may further store corresponding information of the interaction objects, such as classification information, action information, or feature information. The action information may indicate interaction functions to be used by a user, and the action information corresponds to the classification information of the interaction objects. Specifically, the classification information of the interaction objects may be classified into text messages or multimedia messages (audio file or a video file). For example, the classification information may be a text message sent to other users or fiends, images stored in the database 210, photos or video files stored in the mobile device 100, mini games, hand-drawn patterns, music files, or a combination thereof.

In an embodiment, the action information corresponding to a text message may be interaction functions such as sharing, forwarding, or storing the text message. In an embodiment, the action information corresponding to the audio file (multimedia message) may be fast forward playing, reverse playing, stopping, playing, storing, or sharing the audio file. The action information corresponding to a video file (multimedia message) may be sharing, forwarding, storing, or editing the video file. In addition, if the multimedia message is an image with a growing mode, the corresponding action information may be feeding, or taking a walk with the interaction object (details will be described later).

In an embodiment, the classification information of an interaction object can be determined by the server 200 automatically. For example, the server 200 may determine the classification information by the filename extension of the interaction object. In addition, the interaction object may have different action information in accordance with different classification information, and thus the user may interact with the interaction object by using the functions related to the action information. The feature information of the interaction object may be information such as a trigger condition, a living time, a privacy level, a corresponding user, and a lasting time of the interaction object. Details will be described later. If the interaction object is built by the user, it is desired that the feature information is set by the user while uploading the interaction object to the server 200. If the user does not set the feature information of the interaction object, the server 200 may apply default properties to the feature information of the interaction object. For example, the default living time may be 1 month and the default lasting time may be 1 minute. If the interaction object is a built-in object (e.g. a mini game with a growing mode) in the server 200, the feature information of the interaction object is preset and thus the user can not set or alternate the feature information of the interaction object.

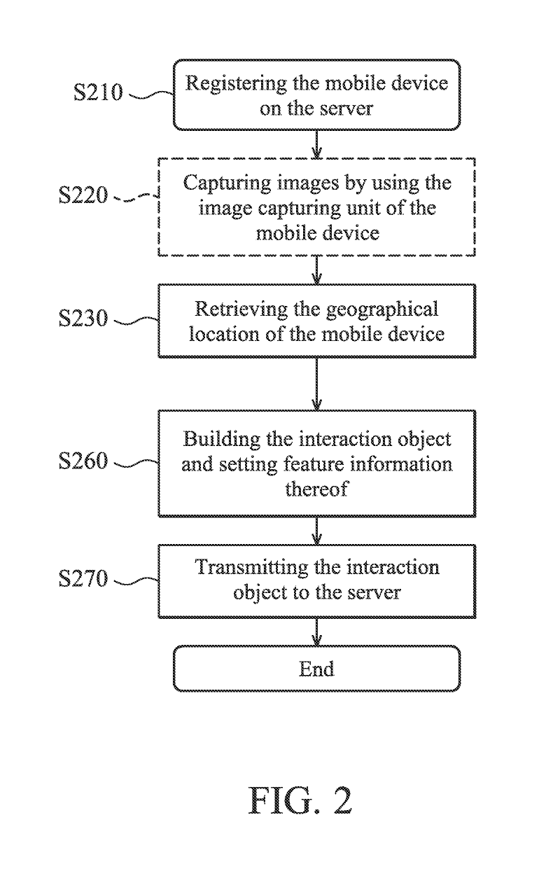

FIG. 2 is a flow chart illustrating a method for building an interaction object according to an embodiment of the invention. In an embodiment, a user registers with the server 200 through the mobile device 100, thereby retrieving interaction information from the server 200 (step S210). Corresponding data of the user can be set in the registration step, such as the cell phone number, email account, a friend list (e.g. registration ID of friends) of the user, or cell phone numbers of friends. Accordingly, when the user has built the interaction object, the server 200 may determine a target user, to whom the interaction object is sent, located at or nearby the geographical location according to the friend list or the cell phone number of the user. Then, the image capturing unit 140 of the mobile device 100 can be used by the user to capture images (step S220), and the location detection unit 170 can be used by the user to determine the geographical location of the mobile device 100 (step S230). In an embodiment, the step S220 can be omitted since the interaction object is not limited to the images or sounds captured by the image capturing unit 140 and/or the audio capturing unit 150. For example, the interaction object may be an existing object in the mobile device 100, or a built-in object or an object existing in the server 200. Then, the mobile device 100 build the captured images as the interaction object and the geographical location (from step S230) as location information of the interaction object to the server 200, and set feature information thereof in the mobile device 100 (step S260). Then, the mobile device 100 may transmit the interaction object to the database 210 of the server 200 (step 270).

In an embodiment, the feature information of the interaction object, such as a photo or a video file, the user may set a living time and a privacy level of the interaction object. Specifically, the user may set the living time of the interaction object as 3 months, and the server 200 may delete the interaction object after 3 months. Similarly, when the user is registering to the server 200, the user may not only provide a friend list (e.g. registration IDs of friends), but also set the privacy level of each friend. Accordingly, only when the privacy level of a friend corresponds to the privacy level of the interaction object, will the server 200 transmit the interaction object to the mobile device of the friend.

In an embodiment, for an interaction object being a text message, the user may specify the lasting time of the text message and the users who are permitted to view the text message. Specifically, the user may freely define the friends, who are permitted to view the text message, and the lasting time (e.g. 10 seconds) of the text message.

In an embodiment, for an interaction object such as images stored in the database 210, the user may set the growing mode of the interaction object, such as a mini game, and set ways to interact with the interaction object. Specifically, the images stored in the server 200 may comprise an egg in the beginning, a chicken in a broken egg shell after a few days, and the chicken grow up gradually, respectively. As long as the user passes by the preset geographical location, the server 200 may transmit different images according to the time duration passed by. In addition, every time when the user receives the images from the server 200, the user may interact with the chicken in the image via the mobile device 100. For example, the display unit 130 may display action information (i.e. interaction functions) of the interaction object (e.g. the chicken), such as feeding the chicken, and taking a walk with the chicken. Thus, the user may select an interaction function by pressing on the button corresponding to the interaction function on the display unit 130, thereby the mobile device 100 may transmit the selected interaction function back to the server 200. The server 200 may integrate the interaction function and calculate the corresponding image of the interaction object (e.g. the chicken). For example, the chicken may be fatter if it is fed more often, and the chicken may have a better look (e.g. healthier) if it takes a walk more often. Specifically, the user or the server 200 may set the bonus after completing the mini game, such as a coupon of a specific store when the chicken grows up successfully, so that it may be more fun to play the game and interact with the interaction object.

In addition, the trigger condition of the feature information may indicate whether the geographical location of the mobile device 100 or other user is located within a range of the location information of the interaction object, or whether a user has arrived at a location corresponding to the location information of the interaction object at specific time. Specifically, if the server 200 determines that one of the aforementioned trigger conditions stands, the server 200 may start to transmit the interaction object to the mobile device 100 or other user, so that the mobile device 100 may perform a corresponding interaction action according to at least one feature of the interaction object, such as displaying a text message, displaying videos or music, or displaying the interaction object, but the invention is not limited thereto.

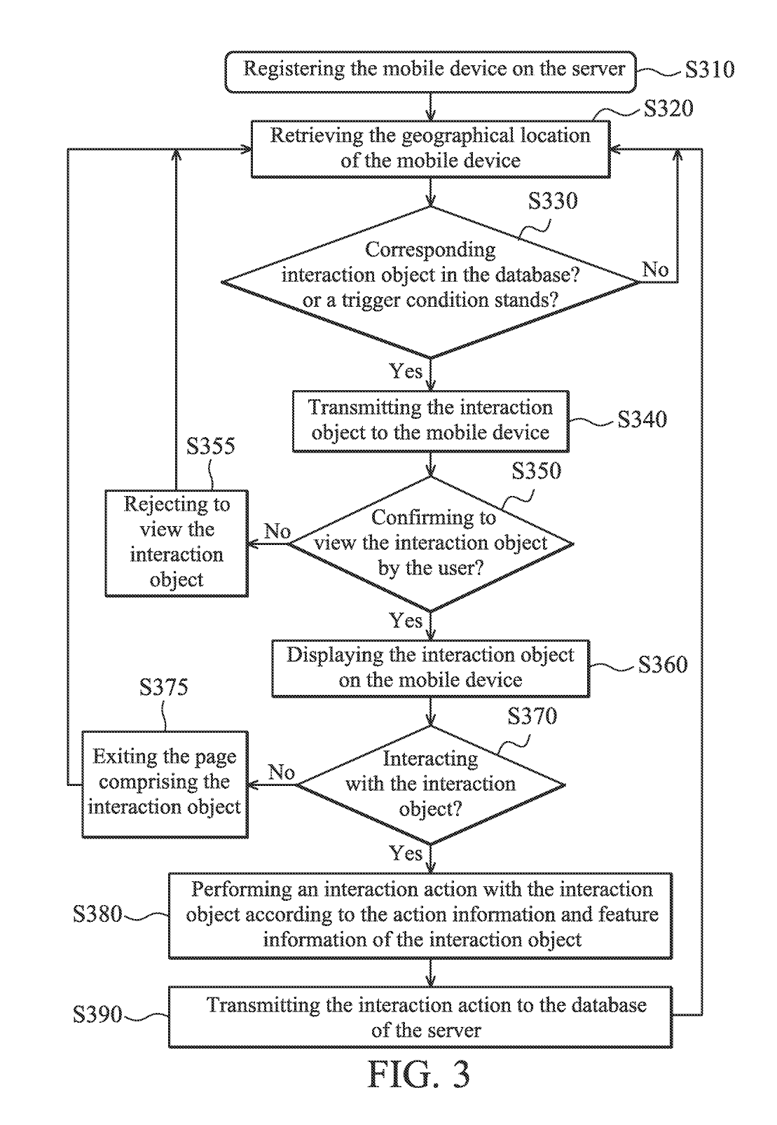

FIG. 3 is a flow chart illustrating an interaction method according to an embodiment of the invention. First, the user has to log onto the server 200 via the mobile device 100, so that the mobile device 100 can be connected to the server 200 to retrieve interaction information (step S310). Then, the location detection unit 170 and/or processing unit 120 may retrieve the geographical location of the mobile device 100, and the retrieved geographical location is transmitted to the server 200 (step S320). The server 200 may further determine whether the location information associated with the interaction object corresponds to the geographical location of the mobile device 100, or whether a trigger condition of a certain interaction object is triggered by the mobile device 100 (step S330). If so, the server 200 may transmit the interaction object associated with the geographical location to the mobile device 100 (step S340). If not, it may indicate that there is no interaction object associated with the location information, and then step S320 is performed.

When an interaction associated with the location information is stored in the database 210 or the mobile device 100 has triggered a trigger condition of a certain interaction object (e.g. within a specific range or a specific time/location), the user may confirm whether to view or execute the interaction object on the mobile device 100 (step S350). If so, the mobile device 100 may display the interaction object (step S360). If not, the mobile device 100 may reject to display the interaction object (step S355), and step S320 is performed. When the mobile device 100 is displaying the interaction object, the user may further determine whether to interact with the interaction object (e.g. according to the action information of the interaction object) (step S370). If so, the user may interact with the interaction object according to the action information and feature information of the interaction object (step S380). If not, it may indicate that the user does not want to interact with the interaction object, and the mobile device 100 may exit the page comprising the interaction object (step S375), and step S320 is performed. After step S380, the mobile device 100 may store the action information responded by the user, and transmit the action information to the server 200, thereby updating the status of the interaction object in the database 210 (step S390), and step S320 is performed.

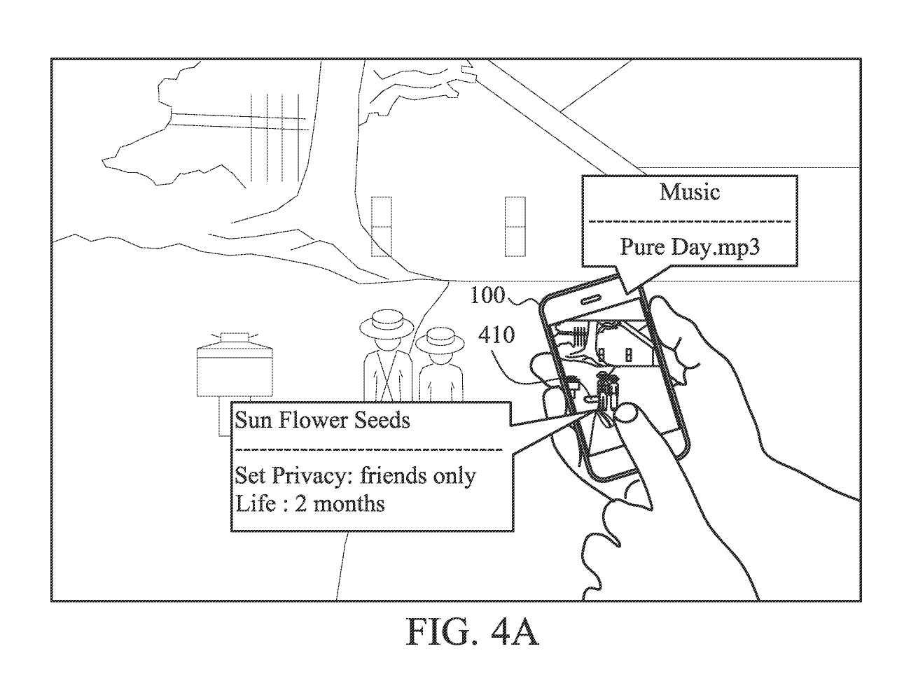

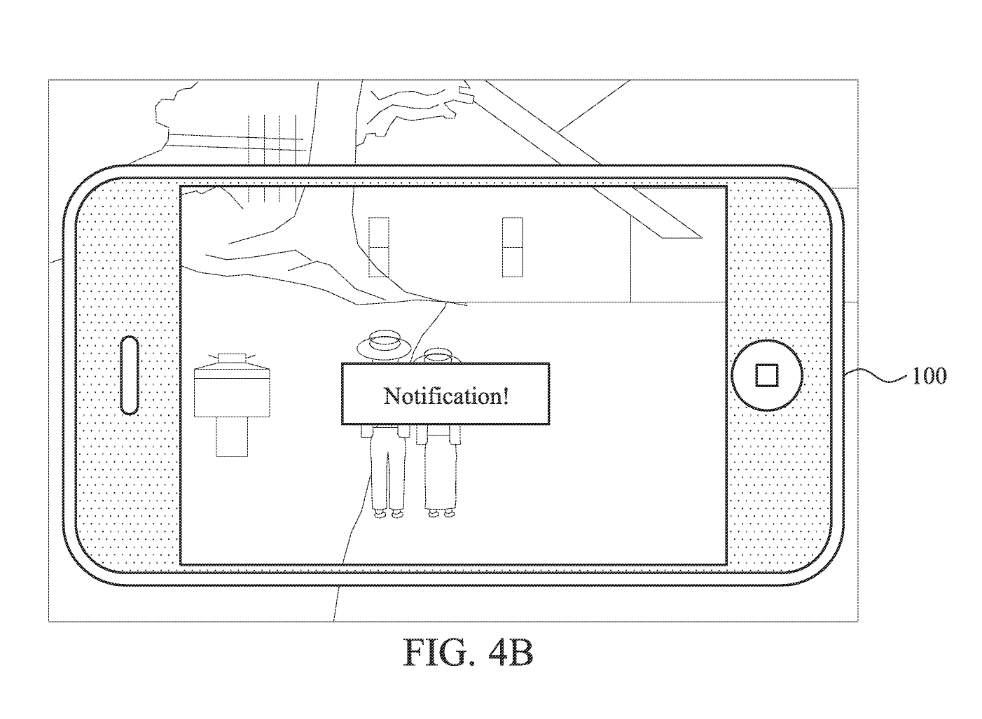

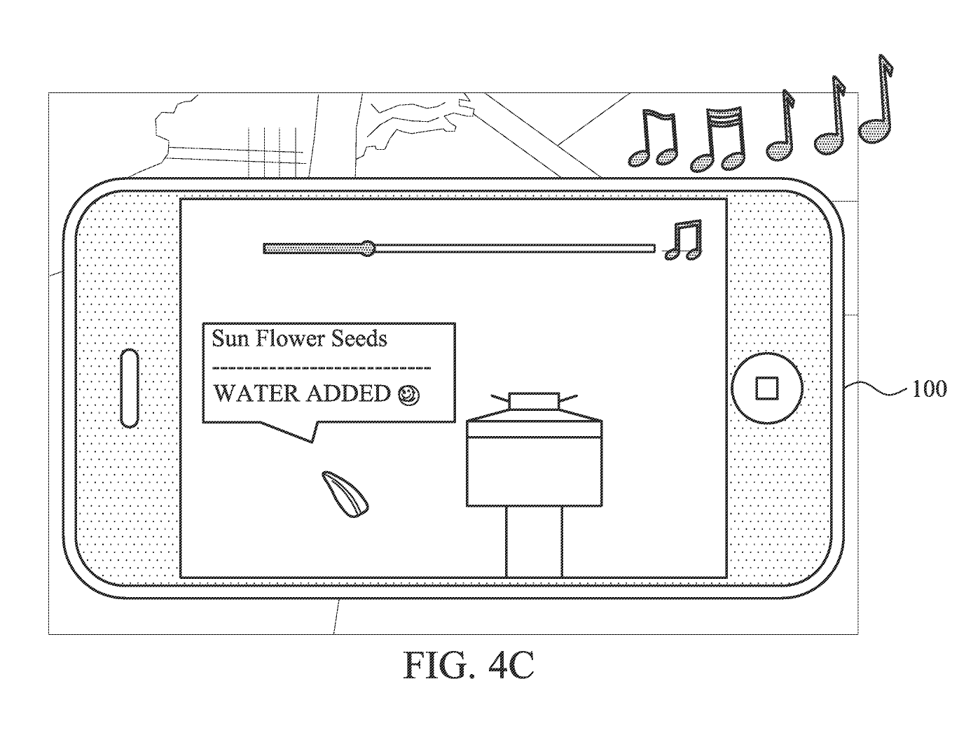

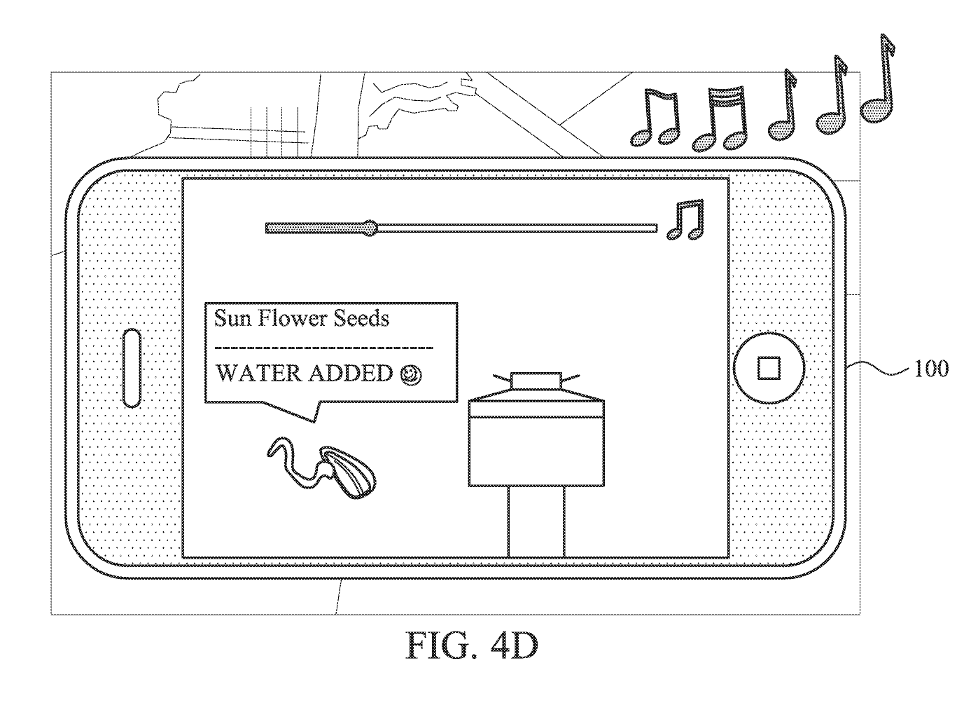

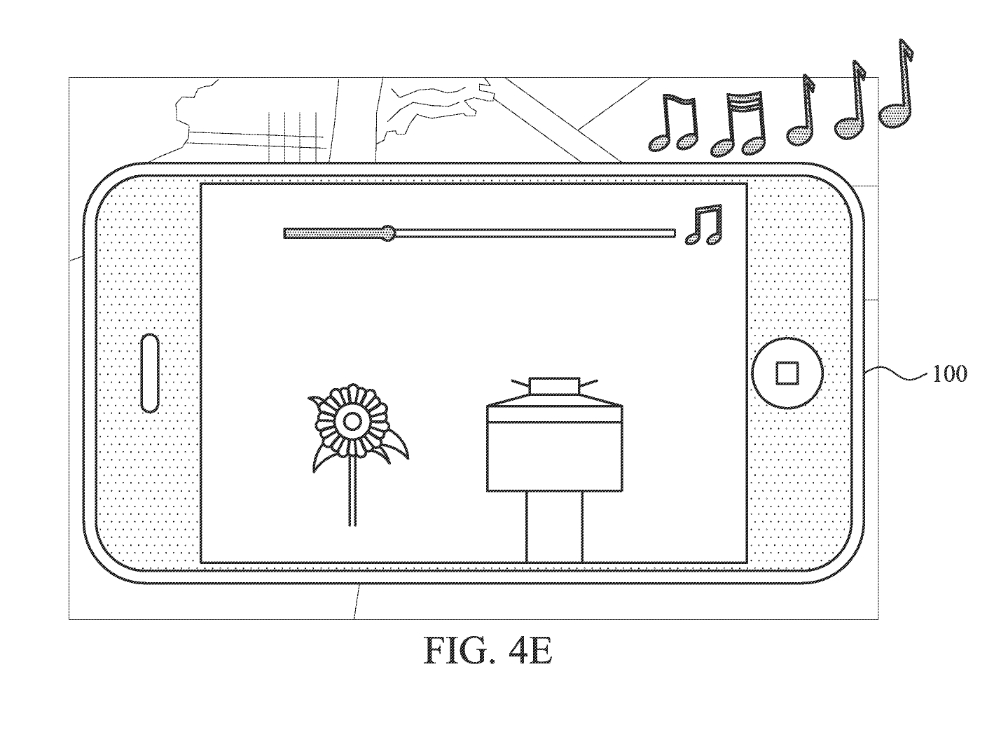

FIGS. 4A-4E are diagrams illustrating a complete procedure of interacting with an interaction object according to an embodiment of the invention, thereby describing the interaction procedure of the invention more clearly. In an embodiment, as illustrated in FIG. 4A, a user A may place a series of images comprising a sunflower seed 410 as an interaction object at the geographical location of the mobile device 100, define a setting to play a music file “Pure Day.mp3” at the geographical location, and set a privacy level of the interaction object, so that only friends of the user A are permitted to interact with the interaction object. The mobile device 100 may transmit the interaction object with feature information and corresponding location information (e.g. the geographical location of the mobile device 100, or a specific trigger condition) to the database 210 of the server 200. Alternatively, the aforementioned series of images comprising the sunflower seed 410 as the interaction object, the music file “Pure Day.mp3”, the feature information, and the privacy level of the interaction object can be preset in the server 200. As illustrated in FIG. 4B, the mobile device 100 may consistently transmit its location information to the server 200. Accordingly, every time when the user A passes by the location associated with the location information of the interaction object, the server 200 may send a notification message to the mobile device 100 to inform the user A of that there is an interaction object to interact with, so that the user A may determine whether to interact with the interaction object.

As illustrated in FIG. 4C, when the user A agrees to interact with the interaction objects 410 (e.g. a sunflower seed accompanying with a music file “Pure Day.mp3”), the server 200 may transmit the interaction objects, the corresponding action information and feature information of the interaction object, which are stored in the database 210, to the mobile device 100. Thus, the mobile device 100 may display the interaction object (e.g. the sunflower seed 410) on the display unit 130, and play the music file “Pure Day.mp3” corresponding to the interaction object. Meanwhile, the user A may perform a function to interact with the sunflower seed 410, such as watering the sunflower seed 410. The user A may also perform functions to interact with another interaction object (e.g. the music file “Pure Day.mp3”), such as pausing or downloading the music file. The mobile device 100 may further record the action information responded by the user A, and transmit the action information to the server 200, thereby updating the status of the interaction object 410 (e.g. the sunflower seed). In addition to the user A, friends of the user A may also interact with the interaction object 410 (e.g. watering the sunflower seed and listening to the music file “Pure Day.mp3”) by their mobile devices when passing by the location of the interaction object 410. Accordingly, the status of the interaction object 410 (e.g. the sunflower seed) can be updated by the user A and his friends, as illustrated in FIG. 4D. At last, the interaction object 410 (e.g. the sunflower seed) may grow up to a sunflower, as illustrated FIG. 4E. It should be noted that the aforementioned embodiment merely disclose a way to interact with the interaction object, but the invention is not limited thereto. In addition, if different users want to interact with the interaction object on the same server by using their mobile devices, the interaction application 122 should be installed on their mobile devices.

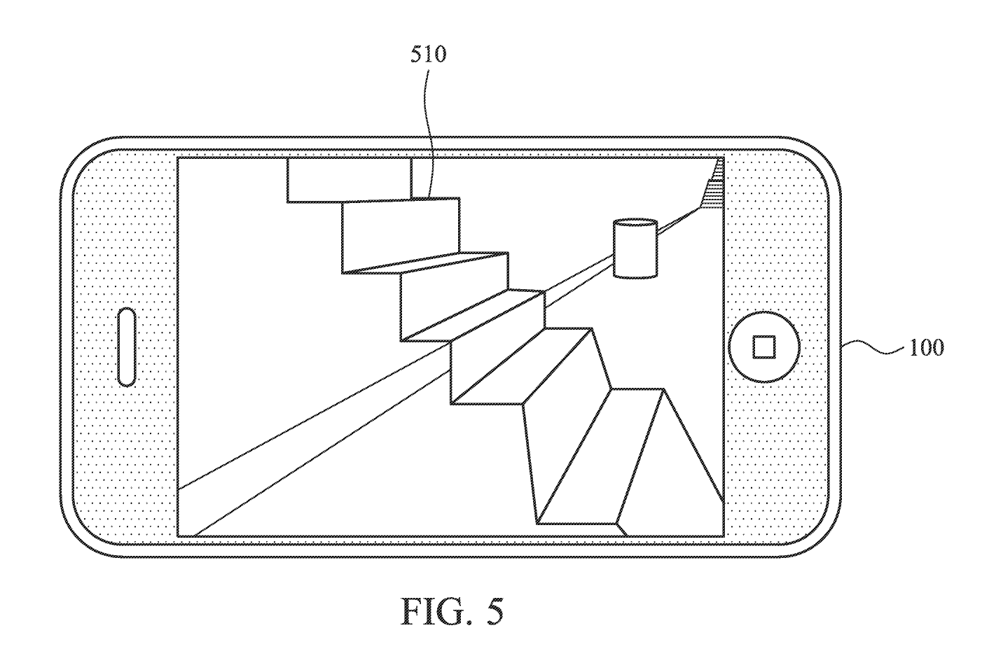

FIG. 5 is a diagram illustrating an interaction action according to another embodiment of the invention. As illustrated in FIG. 5, a user may capture an image by using the image capturing unit 140 of the mobile device 100, and add a hand-drawn pattern 510 as an interaction object to the captured image.

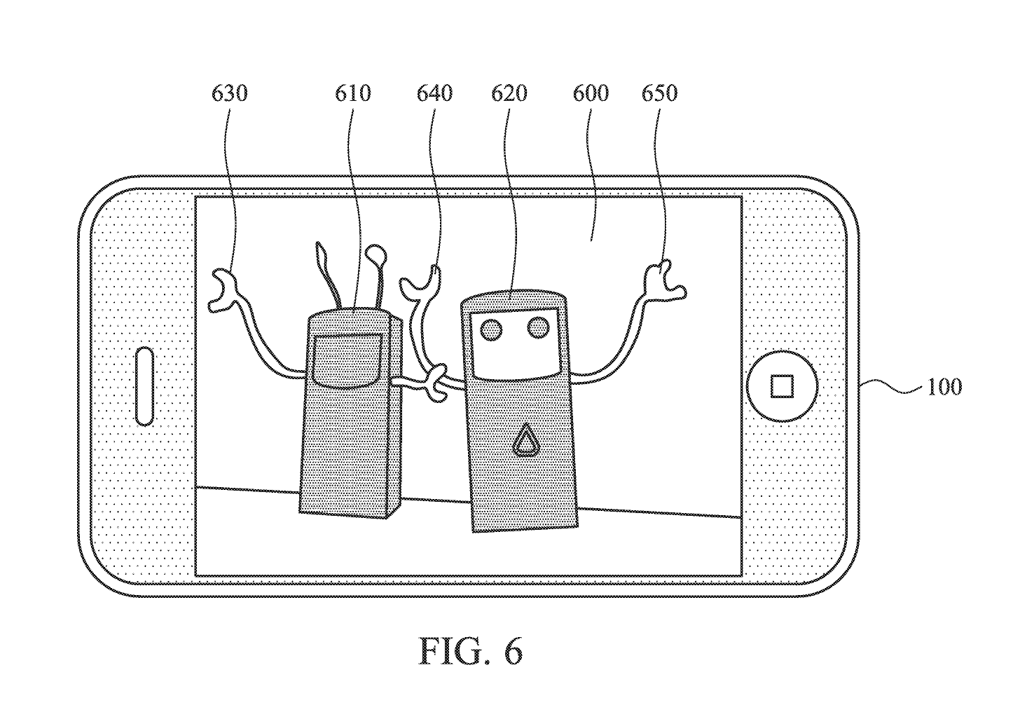

FIG. 6 is a diagram illustrating an interaction action according to yet another embodiment of the invention. As illustrated in FIG. 6, the user A may set interaction objects 610 and 620 on the photo 600, and then store the photo 600 with the interaction objects 610 and 620 in the server 200. When a friend B of the user A is located at a preset geographical location to trigger a trigger condition, the friend B may retrieve the photo 600 and the corresponding interaction objects 610 and 620 by his mobile device 100. In addition, the friend B may further add hand-drawn patterns 630, 640 and 650 on the interaction objects 610 and 620, and transmit the hand-drawn patterns 630, 640 and 650 to the server to update the status of the interaction objects 610 and 620, so that the friend B may interact with the user A.

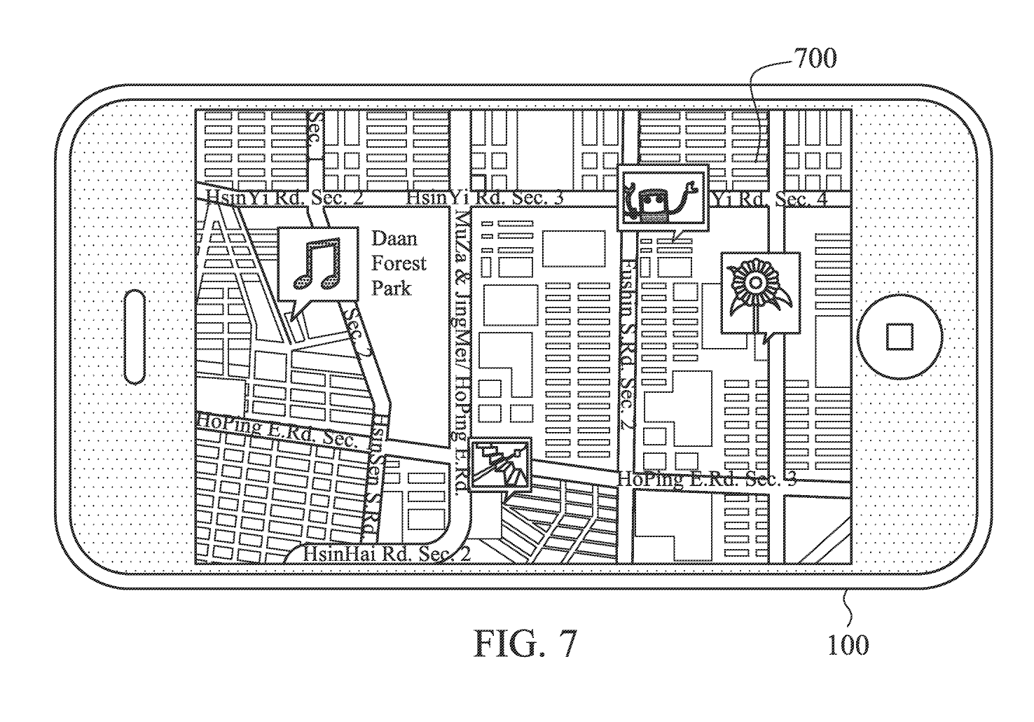

FIG. 7 is a diagram illustrating an interaction action according to yet another embodiment of the invention. As illustrated in FIG. 7, the server 200 may integrate location information corresponding to multiple interaction objects associated with the same user (e.g. the user A), and mark the location information of each interaction object on a map 700. Accordingly, the user A and the user's friends may retrieve the map 700, which has been integrated with the location information of the interaction objects built by the user A, from the server 200 via the mobile device 100.

For those skilled in the art, it should be appreciated that the interaction system 10 in the invention can be applied to interactions in many aspects, so that the location information of interaction objects can be sufficiently used for interaction, such as a role playing game or a feeding game, leaving a message or instructions on a map, a location-based notification (e.g. an alarm clock), an educational application (e.g. marking tags on plants), interacting with videos, interaction advertisements (e.g. getting coupons by playing an interaction game), a theme park (e.g. mixing images in the real world and virtual world), or guidance in a museum, but the invention is not limited thereto.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An interaction system, comprising a mobile device comprising a location detection unit configured to retrieve a geographical location of the mobile device; and
a server configured to retrieve the geographical location of the mobile device, wherein the server comprises a database configured to store at least one interaction object and location information associated with the interaction object, and the server further determines whether the location information of the interaction object corresponds to the geographical location of the mobile device,
wherein when the location information of the interaction object corresponds to the geographical location of the mobile device, the server further transmits the interaction object to the mobile device, so that the mobile device executes the at least one interaction object.

2. The interaction system as claimed in claim 1, wherein the location detection unit comprises a global positioning system, an assisted global positioning system, a radio frequency triangulation device, an electronic compass, or an inertial measurement unit.

3. The interaction system as claimed in claim 1, wherein the mobile device further comprises an image capturing unit configured to capture a first image, and the server further retrieves the first image from the mobile device and match the first image with multiple second images having geographical information stored in the database, thereby retrieving the geographical location of the mobile device.

4. The interaction system as claimed in claim 1, wherein the mobile device further comprises an image capturing unit configured to capture a third image, and the image, and transmits the interaction object and the corresponding location information to the database of the server.

5. The interaction system as claimed in claim 1, wherein the interaction object comprises a text message, an audio file, a video file, a photo, a hand-drawn pattern, a mini game, or a combination thereof.

6. The interaction system as claimed in claim 1, wherein the database further stores classification information and action information associated with the interaction object, and the action information corresponds to the classification information.

7. The interaction system as claimed in claim 1, wherein the server further determines whether the location information associated with the interaction object corresponds to the geographical location of the mobile device according to a trigger condition corresponding to the interaction object, and the trigger condition indicates whether the geographical location of the mobile device is within a range of the location information, or whether a specific user has arrived at a location corresponding to the location information at a specific time.

8. The interaction system as claimed in claim 7, wherein when the mobile device executes the interaction object, a user performs an interaction action according to the classification information and the action information associated with the classification information on the mobile device.

9. The interaction system as claimed in claim 8, wherein when the user performs the interaction action with the interaction object on the mobile device, the mobile device further transmits the interaction action to the server to update a status of the interaction object stored in the database.

10. The interaction system as claimed in claim 1, wherein the database further stores a privacy level, a living time, and a lasting time of the interaction object.
